(19) United States
(12) Patent Application Publication
(10) Pub. No.: US 2026/0003638 A1
(43) Pub. Date: Jan. 1, 2026

(54) COMPUTER DEVICE WITH BACKUP BOOTING MECHANISM

(71) Applicant: Alpha Networks Inc., Hsinchu (TW)

(72) Inventors: Wenbin ZHANG, Hsinchu (TW); Wei ZHANG, Hsinchu (TW); Pengfei SONG, Hsinchu (TW)

(21) Appl. No.: 18/938,004

(22) Filed: Nov. 5, 2024

(30) Foreign Application Priority Data
Jun. 28, 2024 (CN) 202410865377.7

(51) Int. Cl. G06F 9/4401

(52) U.S. Cl. CPC G06F 9/4401

(57) ABSTRACT

A computer device with a backup booting mechanism includes a primary storage medium that stores a default booting program code, a secondary storage medium that stores a backup booting program code, a CPU, and a monitor. When powered on, the CPU accesses and executes the default booting program code, and sends a success signal when successfully booting the computer device with the default booting program code. The monitor times a first time period starting from the monitor being powered on, and if the success signal has not been received prior to the first time period reaching a predetermined threshold, the monitor sends a reset signal to the CPU, and causes the CPU to access the backup booting program code stored in the secondary storage medium. The CPU resets when receiving the reset signal, and accesses and executes the backup booting program code after resetting.

### CROSS-REFERENCE TO RELATED APPLICATION

This application claims priority to Chinese Invention Patent Application No. 202410865377.7, filed on Jun. 28, 2024, the entire disclosure of which is incorporated by reference herein.

### FIELD

The disclosure relates to a computer device, and more particularly to a computer device with a backup booting mechanism.

### BACKGROUND

Referring to FIG. 1, a conventional computer device (e.g., a network switch) includes a central processing unit (CPU) 91, and a storage medium 92 that is electrically connected to the CPU 91 and that stores a booting program code. Booting of the conventional computer device may be done by the CPU 91 accessing and executing the booting program code from the storage medium 92. However, if the storage medium 92 malfunctions or the booting program code is damaged, the CPU 91 will be unable to access the booting program code and thus be unable to boot (or bring up) the conventional computer device.

### SUMMARY

Therefore, an object of the disclosure is to provide a computer device with a backup booting mechanism that can alleviate at least one of the drawbacks of the prior art.

According to the disclosure, a computer device with a backup booting mechanism includes a primary storage medium, a secondary storage medium, a central processing unit (CPU) and a monitor. The primary storage medium is configured to store a default booting program code. The secondary storage medium is configured to store a backup booting program code. The CPU is electrically connected to the primary storage medium and the secondary storage medium, and is configured to be powered on in response to the computer device being powered on, to access and execute the default booting program code upon being powered on, and to send a success signal in response to successfully booting the computer device with the default booting program code. The monitor is electrically connected to the CPU and is configured to be powered on in response to the computer device being powered on. The monitor includes a timer, and a controller that is electrically connected to the timer. The timer is configured to time a first time period starting from the monitor being powered on, to stop timing the first time period in response to receiving the success signal from the CPU prior to the first time period reaching a predetermined threshold, and to send a timeout signal to the controller in response to determining that the success signal has not been received prior to the first time period reaching the predetermined threshold. The controller is configured to send a reset signal to the CPU in response to receiving the timeout signal, and to cause the CPU to access the backup booting program code stored in the secondary storage medium. The CPU is further configured to reset in response to receiving the reset signal, and to access and execute the backup booting program code after resetting.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a block diagram illustrating a conventional computer device.

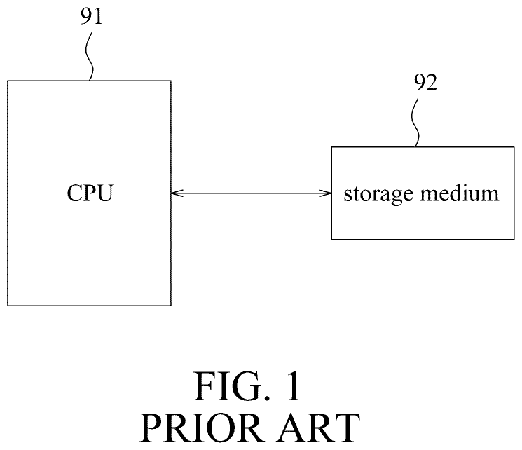

FIG. 2 is a block diagram illustrating a computer device with a backup booting mechanism according to a first embodiment of the disclosure.

FIG. 3 is a block diagram illustrating the computer device with a backup booting mechanism according to a second embodiment of the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

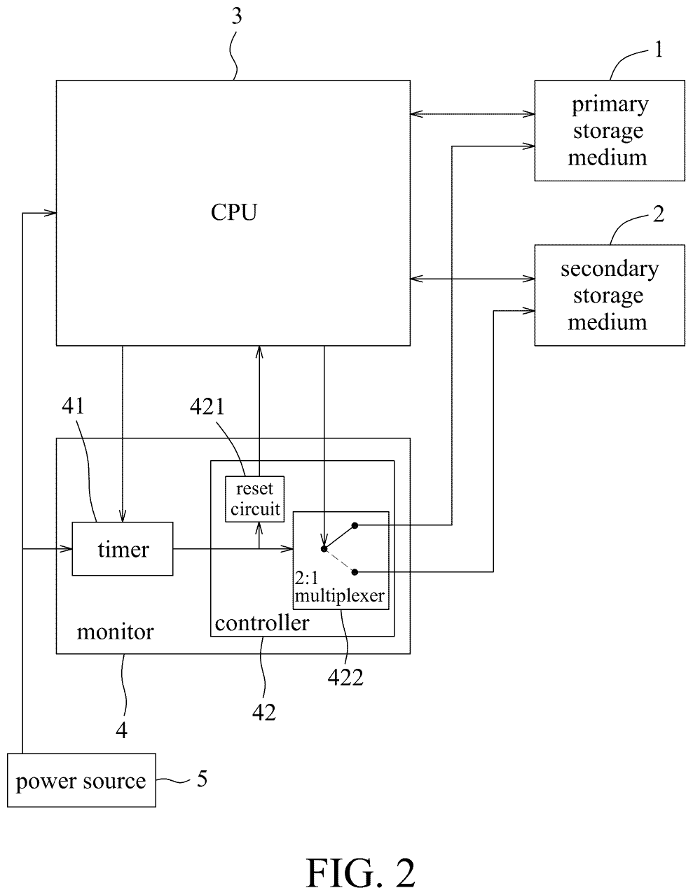

Referring to FIG. 2, a computer device with a backup booting mechanism according to a first embodiment of the disclosure includes a primary storage medium 1, a secondary storage medium 2, a central processing unit (CPU) 3, a monitor 4 and a power source 5. The primary storage medium 1 stores a default booting program code, and the secondary storage medium 2 stores a backup booting program code. The CPU 3 is electrically connected to the primary storage medium 1 and the secondary storage medium 2, and is configured to access and execute the default booting program code or the backup booting program code. The monitor 4 is electrically connected to the primary storage medium 1, the secondary storage medium 2 and the CPU 3. Both the CPU 3 and the monitor 4 are configured to be powered on in response to the power source 5 being powered on (i.e., the computer device being powered on). In this embodiment, the computer device may be implemented as a server, a computer, a device embedded with CPU, etc.

In some embodiments, the primary storage medium 1 and the secondary storage medium 2 may each be a serial peripheral interface (SPI) flash that is electrically connected to the CPU 3 through an SPI interface, or may each be a NAND flash that is electrically connected to the CPU 3 through a NAND interface.

In the first embodiment, the CPU 3 sends a chip select signal to the monitor 4 when it is powered on, and sends a success signal to the monitor 4 in response to successfully booting the computer device with the default booting program code. It should be noted that the success signal may be sent to the monitor 4 through an inter-integrated circuit (I²C) or a general-purpose input/output (GPIO). It should be further noted that the chip select signal sent by the CPU 3 is not directly sent to the primary storage medium 1 and the secondary storage medium 2 respectively through the SPI interface and the NAND interface.

The monitor 4 includes a timer 41 and a controller 42. The timer 41 is electrically connected to the controller 42 and the CPU 3, and is configured to receive the success signal from the CPU 3. The controller 42 is electrically connected to the CPU 3 and is configured to output a reset signal, to receive the chip select signal from the CPU 3 and to send the chip select signal to either the primary storage medium 1 or the secondary storage medium 2. In this embodiment, the controller 42 may include, but is not limited to, one or more of a single core processor, a multi-core processor, a dual-core mobile processor, a microprocessor, a microcontroller, a digital signal processor (DSP), a field-programmable gate array (FPGA), an application specific integrated circuit (ASIC), a radio-frequency integrated circuit (RFIC), a system on a chip (SoC), etc.

The timer 41 is configured to time a first time period starting from the monitor 4 being powered on, and is configured to, in response to receiving the success signal from the CPU 3 prior to the first time period reaching a predetermined threshold, send the success signal to the controller 42. The timer 41 is further configured to, in response to a condition where the success signal has not been received prior to the first time period reaching the predetermined threshold, send a timeout signal to the controller 42. The timer 41 may be implemented by one or a combination of a hardware, a firmware and a software.

The controller 42 includes a reset circuit 421 (e.g., a RESET chipset) and a 2:1 multiplexer 422. The reset circuit 421 is configured to send the reset signal to the CPU 3. The 2:1 multiplexer 422 is configured to establish an electrical connection between the CPU 3 and either the primary storage medium 1 or the secondary storage medium 2, so that the chip select signal received by the controller 42 can be sent to either the primary storage medium 1 or the secondary storage medium 2 based on the electrical connection.

In the first embodiment, when the power source 5 is turned on (i.e., when the monitor 4 is powered on), the timer 41 starts timing the first time period, and the CPU 3 sends the chip select signal to the controller 42. The 2:1 multiplexer 422 of the controller 42 electrically connects the CPU 3 to the primary storage medium 1 by default, and thus the chip select signal is sent to the primary storage medium 1 through the switch 422. The primary storage medium 1 allows access of the default booting program code in response to receiving the chip select signal, thus allowing the CPU 3 to access the default booting program code for booting the computer device.

The CPU 3 accesses and executes the default booting program code to boot (or bring up) the computer device. When the CPU 3 successfully boots (or brings up) the computer device with the default booting program code, the CPU 3 sends the success signal to the timer 41. In response to receiving the success signal from the CPU 3 prior to the first time period reaching the predetermined threshold, the timer 41 stops timing the first time period and sends the success signal to the controller 42. In response to receipt of the success signal, the controller 42 resets the timer 41 to its initial value.

When the CPU 3 fails to boot the computer device with the default booting program code, the CPU 3 will not send the success signal to the timer 41. In response to the condition where the success signal has not been received prior to the first time period reaching the predetermined threshold, the timer 41 sends the timeout signal to the reset circuit 421 and the 2:1 multiplexer 422 of the controller 42, and the controller 42 causes the CPU 3 to access the backup booting program code stored in the secondary storage medium 2.

To describe in further detail, in response to receiving the timeout signal, the reset circuit 421 sends the reset signal to the CPU 3, and the 2:1 multiplexer 422 switches to electrically connect the CPU 3 to the secondary storage medium 2. The CPU 3 resets in response to receiving the reset signal, and sends the chip select signal to the controller 42 again. Since the 2:1 multiplexer 422 is now electrically connecting the CPU 3 to the secondary storage medium 2, the chip select signal would be sent to the secondary storage medium 2 through the 2:1 multiplexer 422. Then, the secondary storage medium 2 allows access of the backup booting program code in response to receiving the chip select signal. Finally, the CPU 3 accesses and executes the backup booting program code after resetting.

When the CPU 3 successfully boots the computer device with the backup booting program code, the CPU 3 generates an update booting program code based on the backup booting program code, and overwrites the default booting program code that is stored in the primary storage medium 1 with the update booting program code.

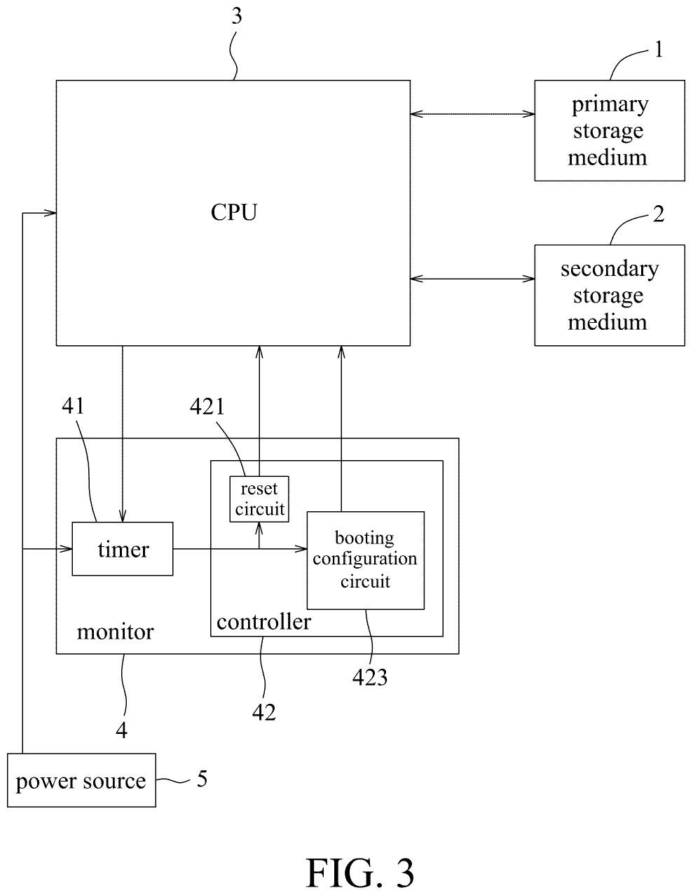

Referring to FIG. 3, the computer device with the backup booting mechanism according to a second embodiment of the disclosure is provided. The second embodiment is similar to the first embodiment. In the second embodiment, the monitor 4 is not electrically connected to the primary storage medium 1 and the secondary storage medium 2, and the controller 42 includes the reset circuit 421 and a booting configuration circuit 423. In this embodiment, the booting configuration circuit 423 (e.g., a shift register) is configured to generate different logical bits for the CPU 3 by booting sequence demand.

In some embodiments, one of the primary storage medium 1 and the secondary storage medium 2 is an SPI flash and is electrically connected to the CPU 3 through an SPI interface, and another one of the primary storage medium 1 and the secondary storage medium 2 is a NAND flash and is electrically connected to the CPU 3 through a NAND interface.

When the CPU 3 successfully boots (or brings up) the computer device with the default booting program code, the CPU 3 sends the success signal to the monitor 4.

In the second embodiment, the monitor 4 includes the timer 41 and the controller 42. The timer 41 operates in the same manner as in the first embodiment. The controller 42 is electrically connected to the timer 41 and the CPU 3, and is configured to output the reset signal, a first booting configuration signal and a second booting configuration signal.

The controller 42 includes the reset circuit 421 and the booting configuration circuit 423. The reset circuit 421 is configured to send the reset signal to the CPU 3. The booting configuration circuit 423 is configured to send the first booting configuration signal to the CPU 3 when the monitor 4 is powered on, and to send the second booting configuration signal to the CPU 3 in response to receiving the timeout signal (e.g., after the reset circuit 421 sends the reset signal to the CPU 3).

In the second embodiment, when the power source 5 is turned on, the monitor 4 is powered on and the timer 41 starts timing the first time period, and the controller 42 sends the first booting configuration signal to the CPU 3. In response to receiving the first booting configuration signal, the CPU 3 sends the chip select signal to the primary storage medium 1. The primary storage medium 1 allows access of the default booting program code in response to receiving the chip select signal, and the CPU 3 accesses the default booting program code for booting the computer device.

When the CPU 3 successfully boots the computer device with the default booting program code, the CPU 3 sends the success signal to the timer 41. In response to receiving the success signal from the CPU 3 prior to the first time period reaching the predetermined threshold, the timer 41 stops timing the first time period and sends the success signal to the controller 42.

When the CPU 3 fails to boot the computer device with the default booting program code, the CPU 3 will not send the success signal to the timer 41. In response to the condition where the success signal has not been received prior to the first time period reaching the predetermined threshold, the timer 41 sends the timeout signal to the reset circuit 421 and the booting configuration circuit 423 of the controller 42, and the controller 42 causes the CPU 3 to access the backup booting program code stored in the secondary storage medium 2.

To describe in further detail, in response to receiving the timeout signal, the reset circuit 421 sends the reset signal to the CPU 3, and then the booting configuration circuit 423 sends the second booting configuration signal to the CPU 3. The CPU 3 resets in response to receiving the reset signal, and sends the chip select signal to the secondary storage medium 2 in response to receiving the second booting configuration signal. The secondary storage medium 2 allows access of the backup booting program code in response to receiving the chip select signal. Finally, the CPU 3 accesses and executes the backup booting program code after resetting.

Similar to the first embodiment, when the CPU 3 successfully boots (or brings up) the computer device with the backup booting program code, the CPU 3 generates the update booting program code based on the backup booting program code, and overwrites the default booting program code that is stored in the primary storage medium 1 with the update booting program code.

In summary, by virtue of having the secondary storage medium 2, if the primary storage medium 1 has malfunctioned or the default booting program code is damaged so that the CPU 3 is unable to boot the computer device prior to the first time period reaching the predetermined threshold, the timer 41 would send the timeout signal to the controller 42 so that the controller 42 causes the CPU 3 to access the backup booting program code stored in the secondary storage medium 2, and to boot the computer device using the backup booting program code. Additionally, the CPU 3 overwrites the primary storage medium 1 with the update booting program code (i.e., the backup booting program code), so that the primary storage medium 1 may be restored.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A computer device with a backup booting mechanism, comprising:
a primary storage medium configured to store a default booting program code;
a secondary storage medium configured to store a backup booting program code;
a central processing unit (CPU) electrically connected to said primary storage medium and said secondary storage medium, and configured to be powered on in response to the computer device being powered on, to access and execute the default booting program code upon being powered on, and to send a success signal in response to successfully booting the computer device with the default booting program code; and
a monitor electrically connected to said CPU and configured to be powered on in response to the computer device being powered on, said monitor including a timer and a controller that is electrically connected to said timer;
wherein said timer is configured to time a first time period starting from said monitor being powered on, to stop timing the first time period in response to receiving the success signal from said CPU prior to the first time period reaching a predetermined threshold, and to send a timeout signal to said controller in response to a condition where the success signal has not been received prior to the first time period reaching the predetermined threshold;
wherein said controller is configured to send a reset signal to said CPU in response to receiving the timeout signal, and to cause said CPU to access the backup booting program code stored in said secondary storage medium; and
wherein said CPU is further configured to reset in response to receiving the reset signal, and to access and execute the backup booting program code after resetting.

2. The computer device as claimed in claim 1, wherein said CPU is further configured to, in response to successfully booting the computer device with the backup booting program code, generate an update booting program code based on the backup booting program code, and overwriting the default booting program code that is stored in said primary storage medium with the update booting program code.

3. The computer device as claimed in claim 1, wherein said controller is further electrically connected to said primary storage medium and said secondary storage medium,
wherein, when the computer device is powered on, said CPU is further configured to send a chip select signal to said controller when powered on, said controller is further configured to send the chip select signal to said primary storage medium in response to receipt of the chip select signal when said monitor is powered on, and said primary storage medium is configured to allow access of the default booting program code in response to receiving the chip select signal, thus allowing said CPU to access the default booting program code for booting the computer device.

4. The computer device as claimed in claim 3, wherein said controller is further configured to send the chip select signal to said secondary storage medium in response to receiving the timeout signal, said secondary storage medium is configured to allow access of the backup booting program code in response to receiving the chip select signal, and said CPU is configured to access the backup booting program code for booting the computer device after resetting.

5. The computer device as claimed in claim 3, wherein each of said primary storage medium and said secondary storage medium is a serial peripheral interface (SPI) flash, and is electrically connected to said CPU through an SPI interface.

6. The computer device as claimed in claim 3, wherein each of said primary storage medium and said secondary storage medium is a NAND flash, and is electrically connected to said CPU through a NAND interface.

7. The computer device as claimed in claim 1, wherein said controller is further configured to send a first booting configuration signal to said CPU when said monitor is powered on, said CPU is further configured to send a chip select signal to said primary storage medium in response to receiving the first booting configuration signal, and said primary storage medium is configured to allow access of the default booting program code in response to receiving the chip select signal, thus allowing said CPU to access the default booting program code for booting the computer device.

8. The computer device as claimed in claim 7, wherein said controller is further configured to send a second booting configuration signal to said CPU in response to receiving the timeout signal, said CPU is further configured, after resetting, to send the chip select signal to said secondary storage medium in response to receiving the second booting configuration signal and to access the backup booting program code for booting the computer device after resetting, and said secondary storage medium is configured to allow access of the backup booting program code in response to receiving the chip select signal.

9. The computer device as claimed in claim 7, wherein one of said primary storage medium and said secondary storage medium is a serial peripheral interface (SPI) flash and is electrically connected to said CPU through an SPI interface, and another one of said primary storage medium and said secondary storage medium is a NAND flash and is electrically connected to said CPU through a NAND interface.

10. The computer device as claimed in claim 1, wherein each of said primary storage medium and said secondary storage medium is a serial peripheral interface (SPI) flash, and is electrically connected to said CPU through an SPI interface.

11. The computer device as claimed in claim 1, wherein each of said primary storage medium and said secondary storage medium is a NAND flash, and is electrically connected to said CPU through a NAND interface.

12. The computer device as claimed in claim 1, wherein one of said primary storage medium and said secondary storage medium is a serial peripheral interface (SPI) flash and is electrically connected to said CPU through an SPI interface, and another one of said primary storage medium and said secondary storage medium is a NAND flash and is electrically connected to said CPU through a NAND interface.
